(19) United States
(12) Patent Application Publication
(10) Pub. No.: US 2024/0300138 A1
(43) Pub. Date: Sep. 12, 2024

(54) METHOD TO PRODUCE FACTORY-FINISHED WOOD PANELS

(71) Applicant: LOUISIANA-PACIFIC CORPORATION, NASHVILLE, TN (US)

(72) Inventors: BRIAN ST. GERMAIN, NASHVILLE, TN (US); DAVID STACKHOUSE, NASHVILLE, TN (US); HEIDI TURNER, NASHVILLE, TN (US)

(21) Appl. No.: 18/503,350

(22) Filed: Nov. 7, 2023

Related U.S. Application Data
(60) Provisional application No. 63/451,243, filed on Mar. 10, 2023.

(51) Int. Cl. B27D 1/08; B27K 5/00; B27M 1/08

(52) U.S. Cl. CPC B27D 1/08; B27K 5/001; B27K 5/007; B27M 1/08; B27K 2200/10; B27K 2200/30

(57) ABSTRACT

A system and process for producing a factory-finished engineered wood-based siding, cladding or panel (e.g., manufactured with wood veneer, strands or fibers). An overlay with a finish coating, not a primer coating, is applied to the engineered wood strand mat prior to applying heat and pressure in a press. The post-press product is cut to form panels, with an edge coating applied to color match the finish coating. The factory-finished product avoids the need to apply a final finish coating of paint on the panel face at the job site after installation, or at a separate, secondary facility post-press.

### FIELD OF INVENTION

This invention relates to a system and process for producing a factory-finished engineered wood-based siding, cladding or panel (e.g., manufactured with wood veneer, strands or fibers).

### BACKGROUND OF INVENTION

Building wall and roof assemblies are layers of several materials, each performing one or more specific functions, that typically are installed separately on the construction sites. Proper installation of the various layers individually and in combination creates challenges not only for the designer, but also for the installers.

A typical layer in most such assembles is a wood panel product, or an integral composite engineered panel product, including, but not limited to, engineered wood composite products formed of lignocellulosic strands or wafers (sometimes referred to as oriented-strand board, or OSB). Products such as OSB have been found to be acceptable alternatives in most cases to dimension lumber or veneer-based wood paneling (e.g., softwood plywood). In general, wood-based composites are produced from wood particles bonded together by an adhesive, the adhesive being selected according to the intended use of, and the properties desired for, the composites. Often, the adhesive is combined with other additives to impart additional properties to the wood composites. Additives can include fire retardants, insecticides, water repellants, and preservatives. A significant advantage of wood-based composites is that they have many of the properties of plywood but can be made from lower grade wood species and waste from other wood product production, and can be formed into panels in lengths and widths independent of size of the harvested timber.

A major reason for increased presence in the marketplace of the above-described alternative product is that these materials exhibit properties like those of the equivalent dimension lumber or plywood, especially, the properties of retaining strength, durability, stability and finish under exposure to expected environmental and use conditions. A class of alternative products are multilayer oriented wood strand boards, such as OSB. Oriented, multilayer wood strand boards are composed of several layers of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above-described type are produced with bending, tensile strengths and face strengths comparable to those of commercial softwood plywood.

U.S. patent application Ser. No. 16/780,726, U.S. Pub. 20200247002 A1, filed Apr. 24, 2020, discloses a process for manufacturing and finishing improved engineered wood siding, and is incorporated herein in its entirety by specific reference for all purposes. It describes an improved engineered wood product, along with several techniques and methods that, used separately or in combination, improve the actual and apparent surface quality of the improved engineered wood product. It includes manufacturing techniques to minimize the presence of sub-surface imperfections that may result in visible telegraphing on the exposed surface. In several embodiments, the invention described therein also uses light diffraction through applied pixilation and a minimally textured finish to help camouflage inherent sub-surface defects. In additional embodiments, it includes the use of certain colors and paint gloss combinations. The synergistic combination of two or more of these methods significantly improve the actual and apparent surface quality and appearance.

The manufacturing process is modified to comprise the addition of a “fines” surface layer (e.g., wood flour) to the mat prior to pressing. The fines layer is increased in basis weight over prior art layers. This higher basis weight fines layer helps hide telegraphing even where no deep or aggressive embossed texture is applied. The fines may be deposited in one layer or more than one layer and may be on, under or between various overlay layers. Further, the fines may be deposited in discreet particle form or may be pre-formed into a loosely bound mat that can be suitably conveyed in the manufacturing process.

One or more layers of an engineered, cellulose or non-cellulose (e.g., paper) based overlay (applied to the surface over, under, or between the fines layer) may also be added. In one embodiment, a medium basis weight paper overlay is combined with a second equal or higher basis weight paper overlay over a higher basis weight fines layer. This combination provides improved surface appearance, even with no or minimal embossing. In another embodiment, the fines are deposited between two overlays with the underlayer being a non-cellulose overlay and the top (over) layer being a cellulose-based overlay.

Smooth caul plates, having no texture/embossing, do not effectively hide subsurface defects that telegraph onto the surface, such as the outline of the wood element (e.g., strands) used to manufacture the engineered wood composite. In addition, smooth caul plates inherently produce smooth, glossy spots on the surface product, which is attributed to process heat, impregnated paper-based overlay, and variations in the underlying density. Such smooth, glossy spots cannot be totally eliminated merely by adjusting the fines layer basis weight (as discussed above), and cannot be totally hidden by using common paint finishes (e.g., exterior latex paint).

As described therein, the process may use caul plates with light embossing/texturing, which impart a minimal embossing/texture to the surface (i.e. the caul plates transfer an inverse image of the texture to the product surface). The caul plate embossing pattern can take a variety of forms, from minimal to aggressive. In one embodiment, the light embossing comprises a series of small dots and dashes. This low level of embossment maintains the appearance of a smooth product surface when viewed from a normal distance but interrupts the light across the surface and camouflages any minor imperfections, such as glossy spots or a wood element outline.

As further described therein, an aggregate-containing paint primer or film coating may be applied. The aggregate may be a fine mineral or non-mineral based material, which provides additional light diffraction and pixilation of the surface, which further minimizes the appearance of minor surface imperfections. The aggregate primer may be applied to the product as a final finishing step after pressing. The aggregate also may be added to final paint or other coatings. Use of certain colors and paint gloss combinations of such coatings will further minimize the appearance of imperfections, while still providing the appearance of being smooth when viewed from a typical distance.

Following pressing, the engineered wood siding panels are cut into a variety and sizes depending on their end use product application, such as, but not limited to, lap, panel, trim, soffit, and vertical siding. In most applications, cut sides of the panels are coated with a factory applied edge primer that will closely match the color of the face primer that was either applied pre-press or post-press to the overlay face. The edge primer improves durability, aesthetics, and provides a suitable surface for adhesion of the final finish coating. Following primer application, the cladding products are packaged and shipped.

Factory primed cladding products require a final finish coat of paint to further improve moisture and UV durability and achieve desired aesthetics, such as color and texture. This final finish coating of paint can be applied after the products are installed onto a house or structure. Alternatively, the final coating of paint may be applied in a factory prior to installation. This type of paint application is typically referred to in the industry as “factory pre-finished” or just “pre-finished” siding. This process requires primed units of products be shipped to a secondary facility, un-packaged, painted, the paint dried and properly cured, and then repackaged in a such a manner as to prevent damage to the finished paint during delivery to the jobsite.

### SUMMARY OF INVENTION

In various exemplary embodiments, the present invention comprises a system and process for producing a factory-finished engineered wood-based siding, cladding or panel (e.g., manufactured with wood veneer, strands or fibers). This invention addresses the problem of the additional cost and time to produce a finished engineered panel product after the pressing, fabricating, and priming steps, as described above. The present invention replaces the primer component of the overlay with a finish coating. The overlay with finish coating is applied to the strand mat prior to the pressing step (i.e., before applying heat and pressure in a press). The edge coating process operates to color match the finish coating. After oven cure and inspection, the panels are packaged into a finished-good unit.

The present invention thus obviates the need to apply a final finish coating of paint after installation on a house or structure, or to ship primed units of product to a secondary facility for application of a final finish coating, curing, and subsequent repackaging. The panels of the present invention have a final finish coating applied prior to the pressing step, and the panels in the finished-good unit are ready for installation and use without application of a subsequent final finish coating.

### BRIEF DESCRIPTION OF THE DRAWINGS

FIG. 1 shows a perspective view of a manufactured wood product base layer with strand orientation.

FIG. 2 shows FIG. 1 with the addition of a fines layer (shown partially).

FIG. 3 shows FIG. 2 with the addition of a performance (e.g., paper) overlay (shown partially).

FIG. 4 shows FIG. 3 with the addition of a factory-applied, pre-press finished coating (shown partially).

FIG. 5 shows a partial cross-section (expanded) of the product of FIG. 4.

FIG. 6 shows a top view of FIG. 4.

FIG. 7 shows a method of production of the panels of the present invention.

### DETAILED DESCRIPTION OF EXEMPLARY EMBODIMENTS

In various exemplary embodiments, the present invention comprises a system and process for producing a factory-finished engineered wood-based siding, cladding or panel (e.g., manufactured with wood veneer, strands or fibers). This invention addresses the problem of the additional cost and time to produce a finished engineered panel product after the pressing, fabricating, and priming steps, as described above. The present invention replaces the primer component of the overlay with a finish coating. The overlay with finish coating is applied to the strand mat prior to the pressing step (i.e., before applying heat and pressure in a press). The edge coating process operates to color match the finish coating. After oven cure and inspection, the panels are packaged into a finished-good unit.

The present invention thus obviates the need to apply a final finish coating of paint after installation on a house or structure, or to ship primed units of product to a secondary facility for application of a final finish coating, curing, and subsequent repackaging. The panels of the present invention have a final finish coating applied prior to the pressing step, and the panels in the finished-good unit are ready for installation and use without application of a subsequent final finish coating.

Engineered wood products, including, but not limited to, oriented-strand board (OSB), fiberboard, laminated strand lumber (LSL), plywood, or laminated veneer lumber (LVL), typically are produced by various primary (and sometimes secondary) pressing processes. Examples of such processes are in U.S. Pat. Nos. 6,461,743; 5,718,786; 5,525,394; 5,470,631; and 5,425,976; and U.S. patent application Ser. No. 15/803,771 (U.S. Pub. No. 20180126584); all of which are incorporated herein in their entireties by specific reference for all purposes. Other aspects are disclosed in U.S. Prov. App. No. 63/451,243, filed Mar. 10, 2023, which is incorporated herein in its entirety by specific reference for all purposes.

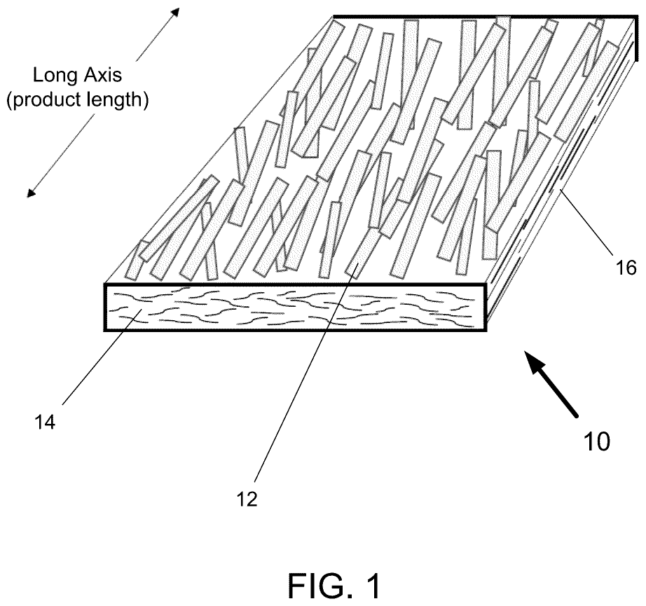

FIG. 1 shows an example of a section (thickness not to scale) of a base mat or layer 10 for lap siding, with end 14 and side 16 edges, shown with the upper surface exposed. The base layer comprises a matrix of wood strands 12 in a particular orientation (in this case, oriented with respect to the long axis of the product).

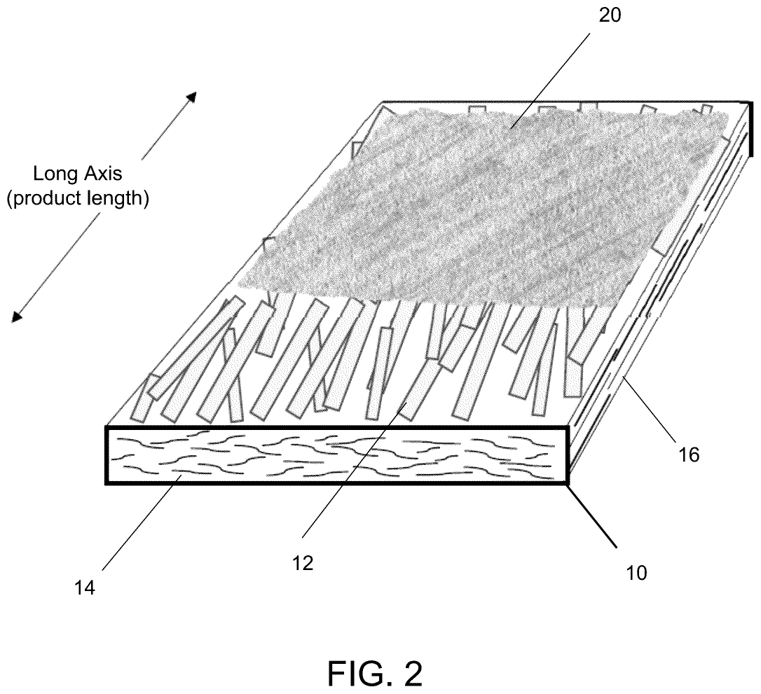

In several exemplary embodiments, the manufacturing process is modified to comprise the addition of a “fines” surface layer (e.g., wood flour) to the mat prior to pressing. FIG. 2 shows the section of FIG. 1 with a fines layer 20 added over the upper surface of the base layer 10. While FIG. 2 shows the fines layer 20 as partially covering the base layer for illustration purposes, the fines layer covers all or substantially all of the upper surface of the base layer 10. The fines layer is optional.

The fines layer 20 is increased in basis weight over similar prior art layers. This higher basis weight fines layer helps hide telegraphing even where no deep or aggressive embossed texture is applied. The fines may be deposited in one layer or more than one layer and may be on, under or between various overlay layers, as described below. Further, the fines may be deposited in discreet particle form or may be pre-formed into a loosely bound mat that can be suitably conveyed in the manufacturing process.

In some exemplary embodiments, the fines (wood flour) layer basis weight can range from about 30 to about 500 pounds per thousand square feet, more preferably from about 200 pounds to about 300 pounds per thousand square feet. In several embodiments, the fines layer basis weight is at least around 225 pounds per thousand square feet or greater. In additional embodiments, the fines layer basis weight is an average of approximately 230 pounds per thousand square feet or greater.

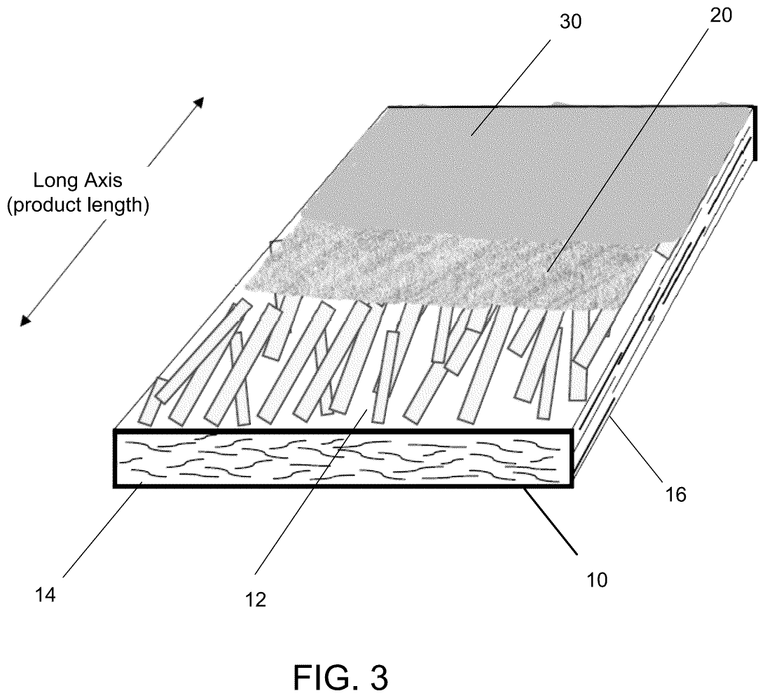

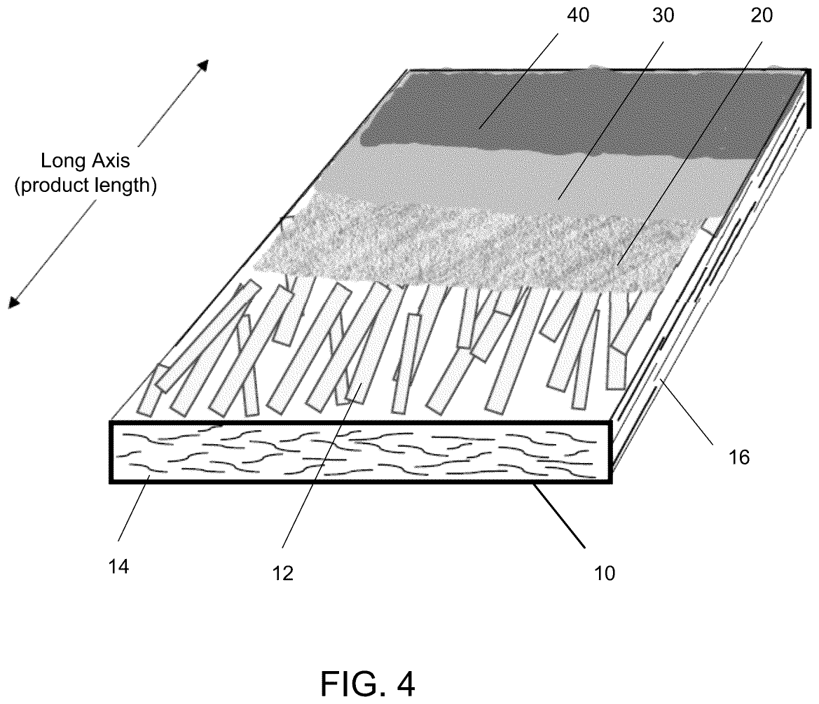

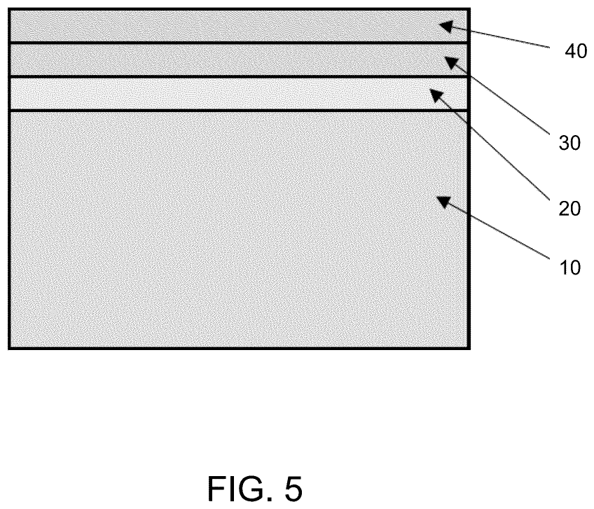

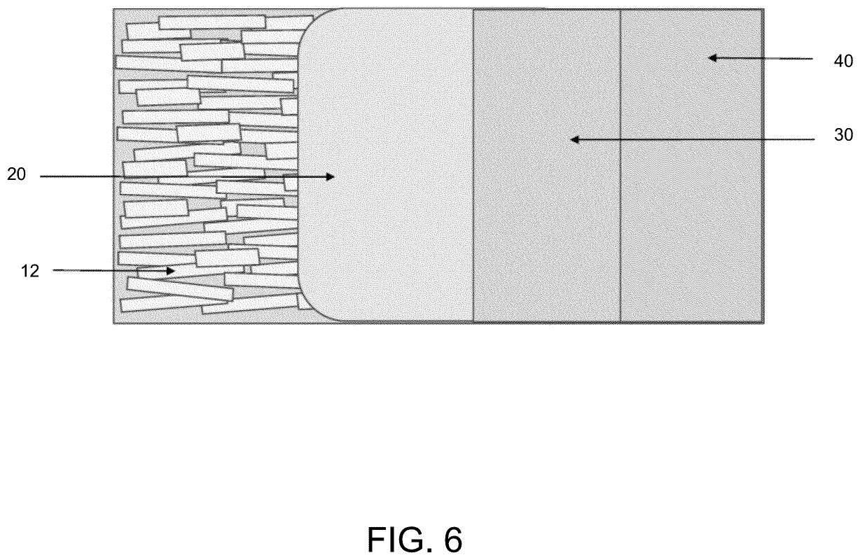

As seen in FIG. 3, one or more layers of an engineered, cellulose or non-cellulose (e.g., paper) based overlay 30 (applied to the surface over, under, or between the fines layer or layers) may also be added. As seen in FIGS. 4-6, a finished coating 40 is applied to or integrated with the overlay 30, prior to application of the overlay to the strand mat 10, with or without a fines layer 20. The finished coating 40 precludes the need for a paint primer or primer coating. The finished coating may contain one or more aggregates. The aggregate may be a fine mineral or non-mineral-based material, which provides additional light diffraction and pixilation of the surface, which further minimizes the appearance of minor surface imperfections. While some of the figures shows the successive layers as partially covering the base layer (and intervening layers) for illustration purposes, each successive layer covers all or substantially all of the upper surface of the preceding layer(s).

The mat comprising the above layers 10, 20, 30, 40 in various combinations is then subjected to heat and pressure in a press with caul plates to form the engineered wood product. Smooth caul plates, having no texture or embossing, do not effectively hide subsurface defects that telegraph onto the surface, such as the outline of the wood element (e.g., strands) used to manufacture the engineered wood composite. In addition, smooth caul plates inherently produce smooth, glossy spots on the surface product. These are attributed to process heat, impregnated paper-based overlay(s), and variations in the underlying layer density. Such smooth, glossy spots cannot be totally eliminated merely by adjusting the fines layer basis weight (as discussed above) and cannot be totally hidden by using common paint finishes (e.g., exterior latex paint).

In several embodiments, the present invention uses caul plates with light embossing or texturing, which impart a minimal embossing, texture or pattern to the upper surface of the outermost layer of the product (i.e., the caul plates transfer an inverse image of the texture to the product surface). The caul plate embossing or texture pattern can take a variety of forms, from minimal (or light or shallow) to aggressive (or heavy or deep). In one embodiment, the light or minimal embossing comprises a series of small dots and dashes, which may be formed in lines or rows, or randomly placed. This low level of embossment maintains the appearance of a smooth product surface when viewed from a normal distance but interrupts the light across the surface and camouflages any minor imperfections, such as glossy spots or a wood element (e.g., strand) outline.

The product thus comes out of the press with a factory-applied finished coating on the outer surface. This eliminates the need for post-press coating with a primer, or post-press coating with a final paint or finish coating, typically performed at a jobsite or in a secondary manufacturing process. The finished coating provides protection for the engineered wood panel.

The edge coating process occurs after the pressed product (sometimes referred to as a “board”) is removed from the press, and panels of desired size are cut therefrom (i.e., the panels are fabricated, and the panel edges fabricated). The edges of the panels are coated in a subsequent secondary manufacturing process, and oven cured. The edge coating process is performed so as to minimize or eliminate edge coating material from extending onto or into the interior of the finished coating surface.

In several embodiments, the finished coating may be colored, and may be color matched for use in both exterior and interior environments. The edge coating and surface coating match 3.0 delta E or less than any given area of product. The surface dry coating thickness ranges from approx. 0.5 mils to approx. 3.0 mils, and the edge dry coating thickness ranges from approx. 2.0 mils to approx. 6.0 mils.

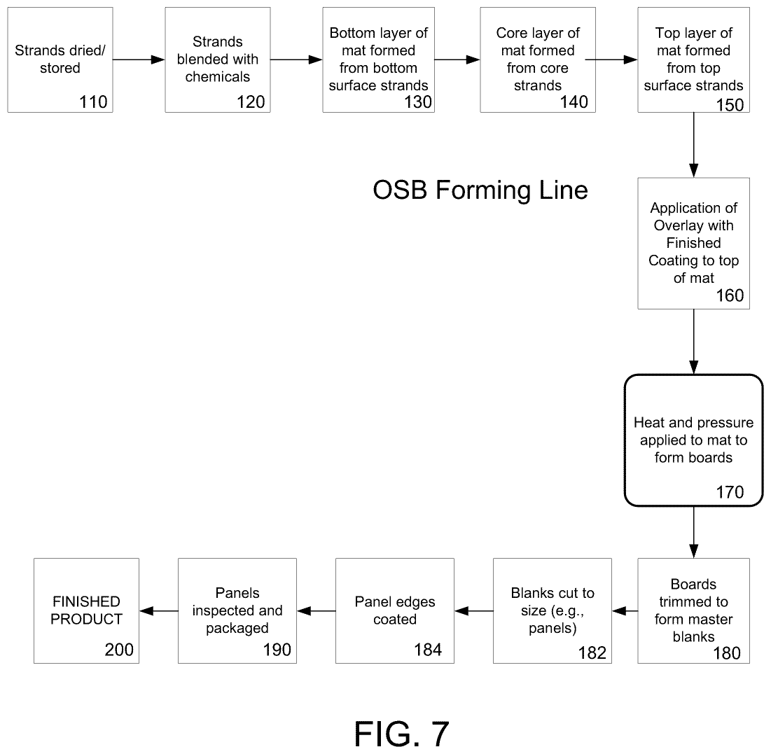

FIG. 7 shows a diagram of an example of this manufacturing process for an OSB engineered-wood product with a factory-applied finish coating. Steps include the producing, drying and storing of wood strands 110, the treatment or blending of designated strands (e.g., bottom, core, top) with applicable chemicals and/or additives (e.g., wax, resin, and the like) 120, the forming of the appropriate layers in order (first bottom surface, then core, then top surface) using designated strands, 130, 140, 150, the application of an overlay with factory-applied finish coating to the top of the mat (i.e., to the upper surface of the top layer) 160, the application of heat and pressure to the mat using a primary press to form boards 170, subsequent trimming of the boards to form master blanks 180 which are cut to size to form panels 182 with edges, and coating of the edges (as described above) 184. The panels are then inspected and packaged 190 as finished products 200 for subsequent storage and shipping. Strands for a particular layer typically are blended with applicable chemicals and/or additives in a bin, separate from strands for other layers, although this is not always the case.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of producing a factory-finished integrated panel, comprising the steps of:
treating some or all of a plurality of wood strands, flakes or chips with adhesives, chemicals, and/or additives;
forming, in a production line, a mat with one or more layers from said treated wood strands, flakes or chips, said mat comprising a top surface and bottom surface;
applying an overlay to the top surface of the mat, said overlay comprising an upper surface with a finish coating; and
applying, in said production line using a production press, heat and pressure to the mat and overlay to form a board with a first surface and a second surface, wherein the first surface comprises the upper surface of the first paper overlay with the finish coating.

2. The method of claim 1, further comprising the steps of:
cutting the board into one or more panels with edges; and
applying an edge coating to the edges of the panels.

3. The method of claim 2, wherein the edge coating color matches the finishing coating on the first paper overlay.

4. The method of claim 2, wherein the edge coating is a finish coating.

5. The method of claim 1, wherein the finish coating is not a primer.

6. The method of claim 2, wherein the edge coating is not a primer.

7. A panel produced according to the method of claim 2.

8. A composite wood product, comprising:
a multiple-layer substrate comprising wood strands, said substrate comprising an upper face and two or more edges; and
an overlay with a top face with a finish coating and a bottom face, said overlay affixed by heat and/or pressure to the upper face.

9. The product of claim 8, wherein the finish coating is not a primer or primer layer.

10. The product of claim 1, wherein the bottom face of the overlay is affixed to the upper face.

11. The product of claim 8, further comprising an edge coating applied to at least one of the two or more edges.

12. The product of claim 11, wherein the edge coating is color matched to the finish coating.

13. The product of claim 11, wherein the edge coating is not a primer or primer coating.

14. The product of claim 8, wherein the overlay is a paper overlay.

15. The product of claim 8, wherein the overlay is a resin-impregnated paper overlay.
